(19) United States
(12) Patent Application Publication
(10) Pub. No.: US 2024/0285024 A1
(43) Pub. Date: Aug. 29, 2024

(54) BLOCK-TYPE OUTSOLE AND METHOD FOR MANUFACTURING SHOE COMPRISING SAME

(71) Applicants: Sang Ok JEONG, Busan (KR); NANOTECH CERAMICS CO., LTD., Busan (KR)

(72) Inventors: Sang Ok JEONG, Busan (KR); Jong Min LIM, Yangsan-si, Gyeongsangnam-do (KR); Sung Young PARK, Busan (KR)

(21) Appl. No.: 17/801,046

(22) PCT Filed: Feb. 15, 2021
(86) PCT No.: PCT/KR2021/001868

§ 371 Date: May 22, 2023

(30) Foreign Application Priority Data
Feb. 19, 2020 (KR) 10-2020-0020506

(51) Int. Cl. A43B 13/12; A43B 13/04; A43B 13/22

(52) U.S. Cl. CPC A43B 13/122; A43B 13/04; A43B 13/223

(57) ABSTRACT

Provided is a block type outsole and a shoe manufacturing method including same that can firmly fix the block type outsole to the base portion without an adhesive, thereby providing the shoe with excellent durability, and undergo no hydrolyzation of an adhesive even in wet places and cause no concern of being detached from the shoe due to reduced adhesion, thereby providing the shoe with excellent waterproofness. In addition, the block type outsole and shoe manufacturing method including same can manufacture a shoe including a block type outsole having abrasion resistance and anti-slip function only by using a simple process, thereby showing excellent process efficiency.

### TECHNICAL FIELD

The present invention relates to a block type outsole and a method of manufacturing a shoe comprising same and, more particularly, to a block type outsole which can be firmly fixed without an adhesive and, thus, has excellent durability, and undergoes no hydrolyzation of an adhesive even in wet places and, thus, causes no concern of being detached from the shoe due to reduced adhesion, and a method of manufacturing a shoe comprising same.

### BACKGROUND ART

In general, a shoe is largely composed of a shoe sole and an upper, and the shoe sole may be classified into an insole, a midsole and an outsole. In addition, the structure of the shoe sole is variously changed and applied depending on the purpose and function of a foot.

In particular, an outsole is a part in direct contact with the ground, is likely to be easily worn and should be able to prevent slipping. The outsole is generally made of a material such as synthetic rubber or foam rubber.

Shoes require various functions depending on the properties of the place where they are worn, and, in particular, it is necessary to add an anti-slip function to work shoes, sneakers and various leisure shoes that require safety and waterproofing.

However, conventional outsoles are usually manufactured through a process of bonding same to the bottom of a shoe by using an adhesive, which has the disadvantage that the adhesive is hydrolyzed in a wet place to lower the adhesion and cause the detachment of the outsole from the shoe. In addition, prefabricated shoes are manufactured depending on a shrinkage rate, which is a property of a natural resin or a synthetic resin, which causes shrinkage, and variations in shrinkage between subsidiary materials cause internal stress changes, thereby reducing durability and waterproofness of the adhesive portion.

### CONTENTS OF THE INVENTION

### Technical Problems

A technical problem to be solved by the present invention is to provide a block type outsole which can be firmly fixed without an adhesive and, thus, has excellent durability, and undergoes no hydrolyzation of an adhesive in wet places and, thus, causes no concern of being detached from the shoe due to reduced adhesion, and a method of manufacturing a shoe comprising same.

### Means of Solving Problem

In order to solve the above-identified technical problem, the present invention provides a block type outsole comprising a fixing portion fitted and fixed to the base portion in which at least one insertion portion is formed; a protrusion portion formed to face the fixing portion; and a connecting portion connecting the fixing portion and the protruding portion, wherein the block type outsole is fitted into the insertion portion and coupled to the base portion.

According to a preferred embodiment of the present invention, the fitting can be formed without an adhesive.

According to a preferred embodiment of the present invention, an intaglio pattern may be formed on the protruding outer surface of the protrusion portion.

According to a preferred embodiment of the present invention, at least one anti-slip pin is formed on the protruding outer surface of the protrusion portion, and the anti-slip pin may be formed to protrude toward the walking path and be exposed to the outside.

According to a preferred embodiment of the present invention, the block type outsole may satisfy the following Formula 1:

$${A}_{F} > {A}_{C} \qquad [ Formula 1 ]$$

wherein A_{F} is a cross-sectional area of the fixing portion, and A_{c} is a cross-sectional area of the connecting portion.

In addition, the present invention provides a shoe comprising any one of the block type outsoles.

According to a preferred embodiment of the present invention, the base portion may be any one selected from the group consisting of a bottom portion of the shoe itself, a midsole, and a base outsole to which a block type outsole may be coupled.

In addition, the present invention provides a method of manufacturing a shoe comprising a block type outsole, comprising the steps of forming a pellet-type rubber composition for manufacturing a shoe; and molding the pellet-type rubber composition to manufacture a shoe, wherein the step of molding the pellet-type rubber composition to manufacture a shoe may comprise the steps that the melt of the pellet-type rubber composition starts to shrink into the form of a shoe comprising a base portion in which at least one insertion portion is formed; a block type outsole is inserted into the insertion portion before the melt completely shrinks; and the shrinkage of the melt is completed to obtain a shoe.

According to a preferred embodiment of the present invention, the step that the block type outsole is inserted may be carried out by fitting the block type outsole into the base portion without an adhesive.

According to a preferred embodiment of the present invention, the step that the block type outsole is inserted into the insertion portion may be carried out within 300 seconds after the melt is molded and begins to shrink.

According to a preferred embodiment of the present invention, the step of molding the pellet-type rubber composition to manufacture a shoe may be carried out by injecting the melt from an injector at 80 to 100° C. into a mold at 160 to 190° C. for 200 to 400 seconds.

According to a preferred embodiment of the present invention, the step of molding the pellet-type rubber composition to manufacture a shoe may manufacture a shoe foamed with 120 to 180%.

### Effect of the Invention

The block type outsole and shoe manufacturing method comprising same of the present invention has effects in that a block type outsole can be firmly fixed without an adhesive and, thus, has excellent durability, and undergoes no hydrolyzation of an adhesive even in wet places and causes no concern of being detached from the shoe due to reduced adhesion and, thus, has excellent waterproofness.

In addition, the block type outsole and shoe manufacturing method comprising same of the present invention can manufacture a shoe comprising a block type outsole having abrasion resistance and anti-slip function only by using a simple process, thereby showing excellent process efficiency.

### BRIEF DESCRIPTION OF THE DRAWINGS

FIG. 1 is a perspective view of a block type outsole according to a preferred embodiment of the present invention.

FIG. 2 is an exploded cross-sectional view of a shoe comprising a block type outsole according to a preferred embodiment of the present invention.

FIG. 3 is an exploded cross-sectional view of a shoe comprising a block type outsole according to a preferred embodiment of the present invention.

FIG. 4 is a bottom perspective view of a shoe comprising a block type outsole according to a preferred embodiment of the present invention.

FIG. 5 is a bottom perspective view of a block type outsole according to a preferred embodiment of the present invention.

FIG. 6 is a process flow chart of a method of manufacturing a shoe comprising a block type outsole according to a preferred embodiment of the present invention.

FIG. 7 is a schematic diagram showing a process flow of a method of manufacturing a shoe comprising a block type outsole according to a preferred embodiment of the present invention.

### DETAILED DESCRIPTION OF THE EMBODIMENTS

The present invention will be described in detail so that a person skilled in the art can easily practice it according to the embodiments of the present invention, with reference to the drawings as attached.

As described above, conventional outsoles are usually manufactured through a process of bonding same to the bottom of a shoe by using an adhesive, which has the limitation that the adhesive is hydrolyzed in a wet place to lower the adhesion and cause the detachment of the outsole from the shoe. In addition, prefabricated shoes are manufactured depending on a shrinkage rate, which is a property of a natural resin or a synthetic resin, which has the limitation that shrinkage occurs, and variations in shrinkage between subsidiary materials cause internal stress changes, thereby reducing durability and waterproofness of the adhesive portion.

Accordingly, the inventors of the present invention sought a solution to the above-identified limitations by providing a block type outsole comprising a fixing portion fitted and fixed to the base portion in which at least one insertion portion is formed; a protrusion portion formed to face the fixing portion; and a connecting portion connecting the fixing portion and the protruding portion, wherein the block type outsole is fitted into the insertion portion and coupled to the base portion.

Accordingly, the present invention can provide a block type outsole which can be effectively fixed without an adhesive and, thus, has excellent durability, and undergoes no hydrolyzation of an adhesive even in wet places and, thus, causes no concern of being detached from the shoe due to reduced adhesion. That is, since the block type outsole can be firmly fixed to the base portion without an adhesive, it has the advantage that it undergoes no hydrolyzation of an adhesive even in wet places and causes no concern of injury, e.g., detachment from the shoe due to reduced adhesion.

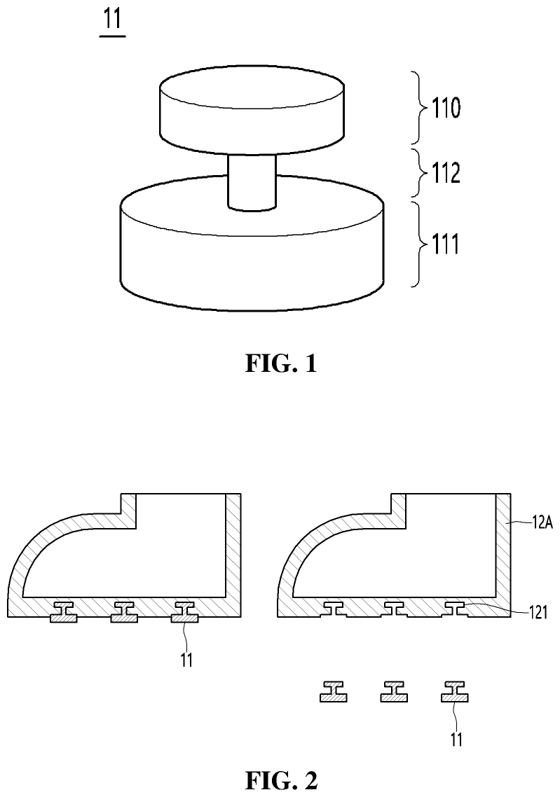

FIG. 1 is a perspective view of a block type outsole according to a preferred embodiment of the present invention. Referring to FIG. 1, the block type outsole 11 comprises a fixing portion 110 and a protrusion portion 111 formed to face the fixing portion 110, and further comprises a connection portion 112 connecting the fixing portion 110 and the protruding portion 111. When the block type outsole 11 is formed to have such a structure, the fixing portion 110 is effective for providing the block type outsole 11 that can be easily fitted into a shoe comprising a base portion. In addition, the protrusion portion 111 is effective for smoothly carrying out the anti-slip function.

On the other hand, the block type outsole 11 shown in FIG. 1 is only one embodiment of Thus, the present invention is not limited to the shape, form, etc. of the the present invention, block type outsole 11.

First, the base portion to which the fixing portion 110 of the block type outsole 11 is fitted will be described.

The base portion refers to a component in which at least one insertion portion into which the block type outsole 11 is fitted is formed, and may provide a substrate into which the block type outsole 11 is fitted to form a shoe.

The base portion may provide an insertion portion which the block type outsole 11 may be coupled to and is not limited as long as it may be coupled to the block type outsole 11 to form a shoe. In some cases, the base portion may refer to the overall product shape of the shoe outsole excluding the block type outsole 11 or may be formed integrally with the shoe such that the block type outsole 11 is fitted thereinto. Also, in some cases, the base portion may be a base outsole into which a midsole or a block type outsole 11 of a shoe may be fitted.

That is, the block type outsole 11 of the present invention may be coupled to the bottom surface of the shoe to form a shoe, coupled to the midsole of the shoe to perform the function of the outsole itself, or inserted into the outsole of a conventional shoe as a base portion to form a shoe.

According to a preferred embodiment of the present invention, the base portion may be any one selected from the group consisting of a bottom portion of a shoe, a midsole, and a base outsole to which the block type outsole 11 may be coupled.

The bottom portion of the shoe itself may indicate the bottom portion of the shoe itself in which an upper and a sole are integrally formed. In this case, at least one insertion portion is formed in the bottom portion of the shoe itself, and the block type outsole 11 is coupled to the insertion portion, thereby forming a shoe.

In addition, when the base portion is a midsole, the block type outsole 11 may be fitted into the insertion portion of the midsole to form a shoe. Similarly, when the base portion is a base outsole, the block type outsole 11 may be fitted into the base outsole to form a shoe comprising a double structured outsole. The base outsole refers to the outsole portion of a conventional shoe comprising an upper, an insole, a midsole and an outsole, as described above, and may refer to an outsole having the function of the base portion into which the block type outsole 11 may be fitted.

FIG. 2 is an exploded cross-sectional view of a shoe comprising a block type outsole according to a preferred embodiment of the present invention. Referring R to FIG. 2, the base portion 12A is implemented as the bottom portion of the shoe itself, and at least one insertion portion 121 is formed in the base portion 12A. By being coupled to the insertion portion 121, the block type outsole 11 can provide shoes with excellent durability, as described below.

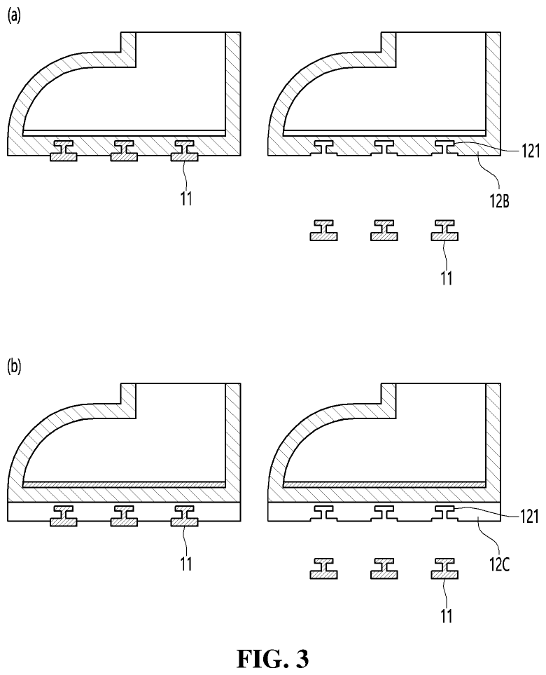

FIG. 3 is an exploded cross-sectional view of a shoe comprising a block type outsole according to a preferred embodiment of the present invention. Referring to FIG. 3(A), a typical shoe comprising an upper, an insole and a midsole is shown, and the base portion 12B is implemented as the midsole of the shoe. At least one insertion portion 121 is formed in the base portion 12B implemented as the midsole. As the block type outsole 11 is coupled to the insertion portion 121 formed in the midsole, the block type outsole 11 can provide shoes with improved durability, as described below.

Also, FIG. 3(B) shows a typical shoe comprising an upper, an insole, a midsole and an outsole and implements the base portion 12C as an outsole. In this case, as described above, a conventional outsole may be referred to as a base outsole 12C (an outsole that acts as the base portion 12), and at least one insertion portion 121 is formed in the base outsole 12C. Coupling the block type outsole 11 to the insertion portion 121 may form a double outsole structure, thereby providing shoes with improved durability and improved abrasion resistance and anti-slip function.

On the other hand, a composition capable of manufacturing shoes with a natural resin or a synthetic resin may be widely used in order to form the base portion 12. Preferably, a foam composition may be used to improve lightness, and, in some cases, rubber-based foams, resin-based foams or mixtures thereof may also be used.

According to a preferred embodiment of the present invention, at least any one selected from the group consisting of ethylene vinyl acetate (EVA), butyl rubber, polyethylene and polyurethane or a mixture thereof may be used.

Ethylene vinyl acetate may be applied instead of existing heavy materials such as natural rubber and synthetic rubber. As one of the ethylene copolymers, it has excellent elasticity and bending resistance and excellent physical properties such as hardness, tensile strength, compression set and light weight, and can achieve weight reduction in shoe manufacturing.

In addition, additives, fillers, crosslinking agents, accelerators, and the like may be appropriately added according to circumstances.

The fillers have the role of reinforcing processability and physical properties and may be classified into organic fillers and inorganic fillers. Organic fillers comprise phenol resin, modified melamine resin, coumarone indene resin, lignin, high styrene, petroleum resin, etc., and inorganic fillers comprise calcium carbonate, magnesium carbonate, barium sulfate, calcium sulfate, silica, clay, carbon black, etc.

In addition, an antiwear agent may be used. The antiwear agent affects compatibility with a composition, processability, antifouling property, elasticity, heat generation, and the like.

Crosslinking agents may comprise those commonly used in the manufacture of outsoles and be selected from dicumyl peroxide (DCP), benzol peroxide, ditetrabutyl peroxide, azodicarbonamide, t-butylperoxyisopropyl carbonate, t-butylperoxylaurylate, t-butylperoxyacetate, di-t-butylperoxyphthaletide, t-dibutylperoxymaleic acid, cyclohexanone peroxide, t-butylcumyl peroside, and methyl ethyl ketone oxide. In addition, in consideration of the peculiar odor of the foamed rubber composition, an odorless crosslinking agent having no odor may preferably be used.

A crosslinking accelerator is used to shorten the molding time and obtain an appropriate crosslinked structure and may comprise those commonly used in the manufacture of outsoles. For example, triallyl cyanurate and the like may be used.

Meanwhile, the base portion 12 comprises at least one insertion portion 121. The insertion portion 121 indicates a space to which the block type outsole 11 is coupled.

The shape of the insertion portion 121 is determined according to the shape of the block type outsole 11. This is because the block type outsole 11 is inserted before the base portion 12 completely shrinks after injection molding of the base portion 12 such that the base portion 12 shrinks according to the shape of the block type outsole 11 to manufacture a shoe comprising the block type outsole 11. According to this process, the shape of the insertion portion 121 is determined according to the shape of the block type outsole 11 such that the block type outsole 11 may be fitted into the insertion portion 121, while minimizing gaps without an adhesive.

At least one insertion portion 121 may be formed in the base portion 12, and the number thereof may be determined according to the purpose of the shoe, the working environment to be worn, and the like. When a plurality of insertion portions 121 are formed in the base portion 12, it is preferable to form a plurality of insertion portions spaced apart at regular intervals, and form relatively many insertion portions on the front and rear of the shoe. In this case, disposing more block type outsoles 11 on the front and rear sides of the shoe that touch the floor more can effectively express the anti-slip function of the shoe.

Next, the fixing portion 110 will be described.

The fixing portion 110 is a component of the block type outsole 11 fitted and fixed to the base portion 12, and the fixing portion 110 acts to prevent the block type outsole 11 coupled to the insertion portion 121 of the base portion 12 from being separated or removed.

The fixing portion 110 of the block type outsole 11 is not limited as long as it has a structure that it can be fitted to the base portion 12. However, the block type outsole 11 may preferably be formed in the form of being stuck so that it is not easily separated after being fitted.

Next, the protruding portion 111 will be described.

The protruding portion 111 of the block type outsole 11 refers to a component at least a part of which protrudes to the outside of the base portion 12 after the block type outsole 11 is fitted to the base portion 12.

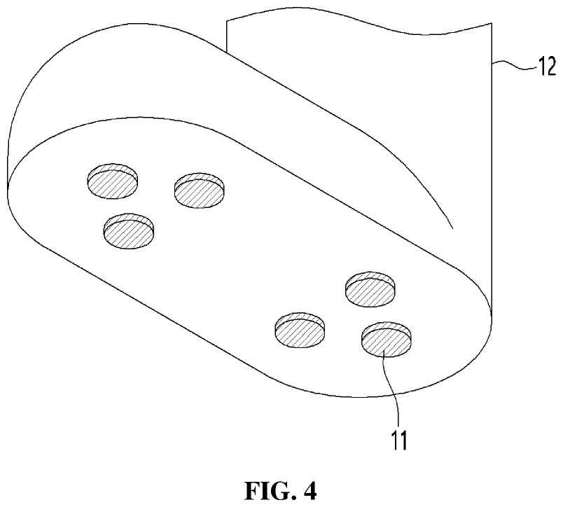

Specifically, FIG. 4 is a bottom perspective view of a shoe comprising a block type outsole according to a preferred embodiment of the present invention. FIG. 4 shows that at least a portion of the block type outsole 11 protrudes to the outside of the base portion 12. As such, the protruding portion 111 is one component of the block type outsole 11, and at least a portion thereof protrudes to the outside of the base portion 12. Therefore, the protrusion portion 111 has the effect of improving wearing comfort by preventing slipping when the user puts on the shoes.

It is sufficient to form a protruding portion 111 in the form that at least a part thereof protrudes to the outside of the base portion 12 such that the protruding portion 111 touches the floor first when the user wearing the shoes steps on the floor, and there is no limitation to the shape thereof. For example, any shape such as a hexagonal column shape, a cylinder shape and a regular hexahedron shape may be used.

On the other hand, according to a preferred embodiment of the present invention, an intaglio pattern may be formed on the protruding outer surface of the protruding portion 111. Therefore, the protruding portion 111 has the effect of adding an anti-slip function to a shoe.

In this case, the ‘protruding outer surface’ may refer to one side of the protruding portion 111 that touches the floor first when the user wearing the shoes steps on the floor.

Specifically, an outsole should generally be able to respond appropriately to uneven ground conditions during walking. In particular, when the surface of the road is humid and when moisture or oil forms a film at the interface of the ground, the frictional force between the ground and the outsole decreases. Thus, a shoe is essentially required to have anti-slip performance. In order to satisfy this demand, an intaglio pattern is formed on the protruding outer surface of the protruding portion 111 such that anti-slip performance may be further added to the shoe, thereby improving the usability of the shoe.

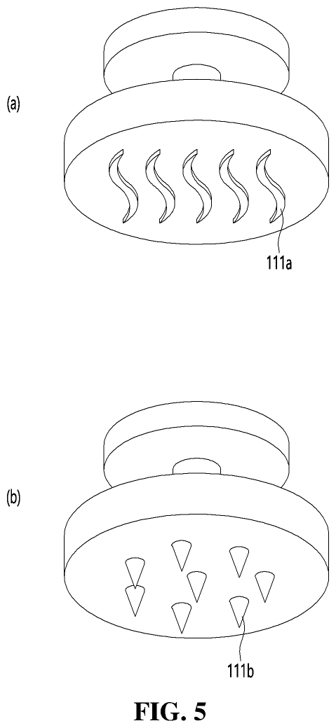

Specifically, FIG. 5 is a bottom perspective view of a block type outsole according to a preferred embodiment of the present invention. FIG. 5(A) shows that an intaglio pattern 111A is formed on the protruding outer surface of the protruding portion 111. In this way, the formation of the intaglio pattern 111A on the protruding outer surface of the protrusion 111 of the block type outsole 11 can improve the anti-slip performance, as described above.

According to another preferred embodiment of the present invention, at least one anti-slip pin is formed on the protruding outer surface of the protruding portion 111, and the anti-slip pin protrudes toward the walking path and is exposed to the outside.

In this case, the anti-slip pin is inserted into the walking path whenever the shoes touch the walking path, thereby generating a spike effect that the anti-slip pin is embedded in the walking path, or maximizing the pressure applied to the anti-slip pin. Accordingly, slipping of shoes during walking is prevented or greatly reduced, thereby improving pedestrian's safety.

FIG. 5(B) shows that at least one anti-slip pin 111B is formed on the protruding outer surface of the protruding portion 111, protrudes toward the walking path and is exposed to the outside.

On the other hand, the anti-slip pin 11B may be formed of an anti-slip material having rigidity and elasticity and strong frictional force, for example, rubber such as synthetic rubber and natural rubber, and silicon.

Next, the connecting portion 112 will be described.

The connection portion 112 is a portion connecting the fixing portion 110 and the protruding portion 111, and, as described above, firmly fixes the block type outsole 11 to the insertion portion 121 of the base portion 12 to effectively fix the block type outsole without an adhesive such that the block type outsole has excellent durability and undergoes no hydrolyzation of an adhesive even in wet places, thereby preventing the outsole from being detached from the shoe due to reduced adhesion. In addition, the connecting portion 112 can maintain the structure in which at least a portion of the protruding portion 111 protrudes to the outside, thereby improving the wearing comfort of the shoe and the usefulness of the shoe in various environments.

The connecting portion 112 may be formed in a form connecting the fixing portion 110 and the protruding portion 111, and the connecting portion 112 may preferably be formed to have a narrower cross-sectional area parallel to the bottom surface of the shoe than the fixing portion 110 and the protruding portion 111.

FIGS. 1 and 2 show that the cross-sectional area of the connecting portion 111 parallel to the bottom surface of the shoe is narrower than the cross-sectional area of the fixing portion 110 and the protruding portion 111 parallel to the bottom surface of the shoe. When the connection portion 111 is manufactured in such a form, the fixing portion 110 performs fitting the outsole into the base portion 12 to provide the outsole with excellent durability, and the protrusion portion 111 is effective for smoothly carrying out the anti-slip function.

According to a preferred embodiment of the present invention, the outsole may satisfy the following Formula 1:

$${A}_{F} > {A}_{C} \qquad [ Formula 1 ]$$

wherein A_{F} is a cross-sectional area of the fixing portion, and A_{c} is a cross-sectional area of the connecting portion.

When satisfying Formula 1, the outsole can show excellent durability, waterproofness, anti-slip performance and comfort, as described above. On the other hand, if Formula 1 is not satisfied, the fixing portion 110 may carry out the fitting not relatively firmly, thereby causing the problem of lowering durability.

That is, the block type outsole 11 of the present invention can prevent slipping and improve the user's wearing comfort. FIG. 3 shows that the block type outsole 11 is fitted into the base portion 10, and the block type outsole 11 partially protrudes out of the base portion 10. In this way, the block type outsole 11 at least a part of which protrudes can act to prevent slipping and improve comfort.

According to a preferred embodiment of the present invention, the fitting can be formed without an adhesive. That is, the present invention is characterized in that the block type outsole 11 can be fitted into the insertion portion of the base portion 10 without using an adhesive or an agent containing an adhesive component, thereby improving durability and waterproofness of the outsole. Specifically, the block type outsole using no adhesive undergoes no hydrolyzation of an adhesive even in wet places and, thus, causes no concern of being detached from the shoe. Further, manufacturing a shoe comprising a block type outsole fitted in a process step, unlike conventional prefabricated shoes, causes no concern that the outsole may easily be separated even by physical force applied from the outside.

In addition, the present invention provides a shoe comprising any one of the block type outsoles 11 described above.

Furthermore, the present invention provides a method of manufacturing a shoe comprising the step of molding a melt of a pellet-type rubber composition for manufacturing a shoe, wherein the step of molding the pellet-type rubber composition may comprise the steps that the melt of the pellet-type rubber composition starts to shrink into the form of a shoe comprising a base portion in which at least one insertion portion is formed; a block type outsole is inserted into the insertion portion before the melt completely shrinks; and the shrinkage of the melt is completed such that the block type outsole is fixed in close contact with the insertion portion.

Therefore, the present invention has the effect of providing a shoe with excellent durability comprising an outsole which can be firmly fixed without an adhesive through a simple process, and undergoes no hydrolyzation of an adhesive even in wet places and causes no concern of being detached from the shoe due to reduced adhesion.

Specifically, a process of applying an adhesive was required in the past, and an individual assembling process should be essentially contained to the process of manufacturing prefabricated shoes. However, the present invention does not require an adhesive applying process or an individual assembling process at all, and a shoe comprising a block type outsole that can be firmly fixed without an adhesive may be manufactured by adjusting the shrinkage rate, thereby significantly reducing the process cost and achieving excellent process efficiency, as described below.

Hereinafter, the present invention will be described in detail except for the contents overlapping with the above-described contents.

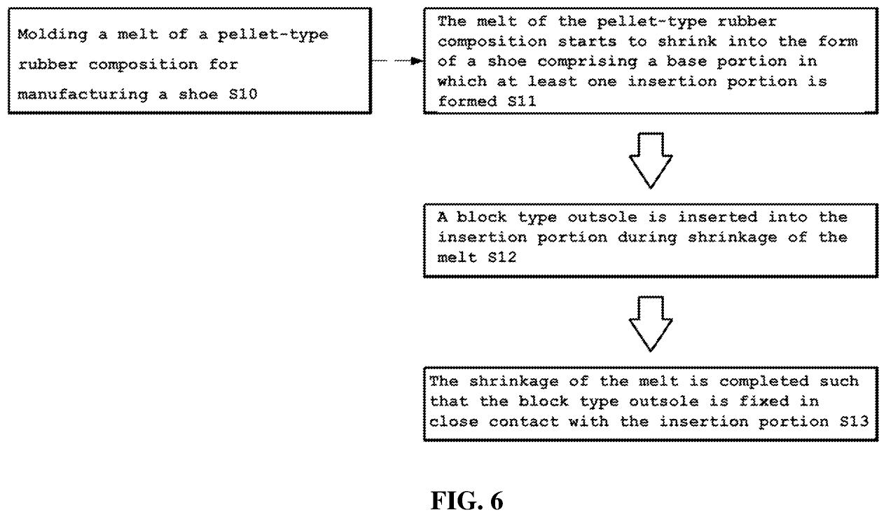

FIG. 6 is a process flow chart of a method of manufacturing a shoe comprising a block type outsole according to a preferred embodiment of the present invention. Referring to FIG. 6, the shoe manufacturing method of the present invention comprises a step of molding a melt of a pellet-type rubber composition for manufacturing a shoe S10. The step of molding the melt of the pellet-type rubber composition S10 may comprise the steps that the melt of the pellet-type rubber composition starts to shrink into the form of a shoe comprising a base portion in which at least one insertion portion is formed S11; a block type outsole is inserted into the insertion portion before the melt completely shrinks S12; and the shrinkage of the melt is completed such that the block type outsole is fixed in close contact with the insertion portion S13.

First, the step of molding the melt of the pellet-type rubber composition for manufacturing a shoe S10 will be described.

The pellet-type composition for manufacturing a shoe is a composition capable of forming a shoe, and the melt of the pellet-type rubber composition for manufacturing a shoe is a material in which the pellet-type composition is melted.

Preferably, the step of forming the pellet-type rubber composition for manufacturing a shoe may be carried out prior to step S10. The step of forming the pellet-type rubber composition for manufacturing a shoe may refer to the step of preparing a composition capable of forming the above-described base portion 12, which may be carried out by mixing materials capable of forming the base portion 12 and may be carried through a kneader.

In addition, as described above, an additive, a crosslinking accelerator, etc., in addition to a resin, may be added and mixed according to circumstances. In this case, it is preferable to make the mixing order and time of the resin, additive and crosslinking accelerator different.

According to a preferred embodiment of the present invention, the additive may be added after first adding the resin at 50 to 90° C. for 2 to 8 minutes. It is preferable to further mix for 5 to 10 minutes after adding the additive. In addition, the crosslinking accelerator is preferably added in the last order. When the crosslinking accelerator is added, it is preferable to further mix for 0.5 to 4 minutes. In this case, a more uniformly mixed mixture can be prepared.

According to a preferred embodiment of the present invention, a pellet-type rubber composition may be formed by pelletizing the mixture. In this regard, the pellet-type rubber composition refers to a rubber composition for manufacturing a shoe pelletized and manufactured in the form of pellets.

Preferably, a pellet-type rubber composition may be prepared by extruding and cutting the mixture. That is, the rubber composition may be produced in a pellet shape by extruding the mixed mixture through the kneader and then cutting and pelletizing same.

The pelletizing may be carried out by using an extruder, and the extrusion is preferably carried out in a temperature range of 50 to 150° C. More preferably, the extrusion may be carried out at a temperature range of 60 to 120° C. After the extrusion through the extruder, cutting is carried out to pelletize the mixture to produce pellets.

In addition, pelletizing may preferably be carried out by rolling the mixture and then extruding and cutting same. At this time, the rolling may be carried out in appropriate temperature and time ranges by a conventional method of rolling a resin mixture. Preferably, the rolling may be carried out at 50 to 90° C. for 2 to 8 minutes.

That is, step S10 is a step of molding the melt of the prepared pellet-type rubber composition, as described above, through which a shoe comprising the block type outsole 11 may be finally manufactured.

The step S10 may comprise the steps that the melt of the pellet-type rubber composition starts to shrink into the form of a shoe comprising a base portion in which at least one insertion portion is formed S11; a block type outsole is inserted into the insertion portion before the melt completely shrinks S12; and the shrinkage of the melt is completed such that the block type outsole is fixed in close contact with the insertion portion S13.

That is, the present invention provides a shoe shape formed by the shrinkage of the melt of the pellet-type rubber composition in the process of being solidified. The present invention can provide a shoe wherein the block type outsole 11 is firmly fixed in close contact with the insertion portion without an adhesive by inserting the block type outsole 11 into the insertion portion 121 of the base portion 12 ‘during shrinkage,’ i.e., before the melt is molded and completely shrinks after the melt starts to shrink into a shoe shape.

Step S12 is a process step for firmly fitting the block type outsole 11 to the shoe shape comprising the base portion 12 in which at least one insertion portion 121 is formed without an adhesive. By carrying out the step S12, the present invention can provide a shoe with excellent durability by firmly fixing the block type outsole 11 to the insertion portion without an adhesive, and a shoe with excellent waterproofness by undergoing no hydrolyzation of an adhesive even in wet places and causing no concern of being detached from the shoe due to reduced adhesion.

According to a preferred embodiment of the present invention, in the step S12, the shrinkage rate may be adjusted by fixing the pellets that start to shrink in the step S11 by using a last, which may prevent over-contraction and fix the block type outsole.

In general, a last is a frame for shaping a shoe and is a word derived from the old English word “least” (copy a foot). In the present invention, a shoe comprising a block type outsole 11 may be manufactured by coupling the block type outsole 11 in a state where the outer surface of the last is covered, and then separating the last therefrom and inserting the block type outsole 11 into the space corresponding to the last shape.

In this way, inserting the block type outsole 11 by the fitting method by adjusting the shrinkage rate provides an insertion portion 121 into which the block type outsole 11 may be fitted and gaps are minimized without an adhesive, thereby providing a shoe having excellent durability.

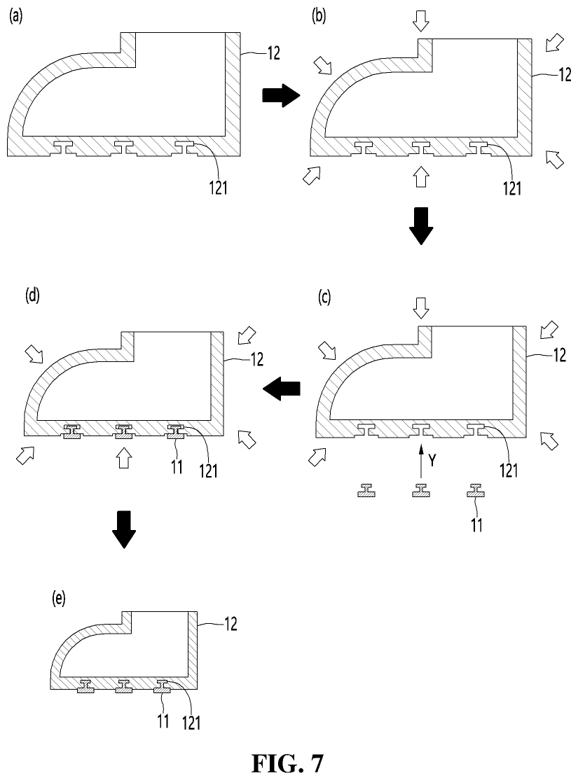

FIG. 7 is a schematic diagram showing a process flow of a method of manufacturing a shoe comprising a block type outsole according to a preferred embodiment of the present invention. Referring to FIG. 7, FIG. 7(A), FIG. 7(B), FIG. 7(C) and FIG. 7(D) are schematic diagrams showing the manufacturing process of the present invention over time.

Referring to FIG. 7(A), the present invention molds a melt of a pellet-type rubber composition for manufacturing a shoe. That is, the melt of the pellet-type rubber composition is molded to prepare a melt in the form of the base portion 12 in which at least one insertion portion 121 is formed. Referring to FIG. 7(B), the melt begins to shrink into the shoe shape comprising the base portion 12 in which at least one insertion portion 121 is formed. Next, referring to FIG. 7(C), the melt continuously shrinks, and the block type outsole 11 is inserted into the insertion portion while the melt shrinks. As a result, as shown in FIG. 7(D), the melt further shrinks in the state where the block type outsole 11 is inserted, and, when the shrinkage of the melt is completed as shown in FIG. 7(E), the block type outsole 11 is fixed in close contact with the insertion portion 121.

According to a preferred embodiment of the present invention, the step S12 is preferably carried out within 300 seconds after the pellets are molded and begin to shrink in the step S11. In this case, the last may be immediately inserted into the shape of the shoe that starts to be injected, thereby preventing over-contraction and effectively maintaining the shape. If step S12 is carried out beyond the time period, over-contraction may occur and it may be difficult to maintain the shape to couple the block type outsole 11.

On the other hand, injection molding may be carried out according to the method and conditions used in manufacturing conventional injection-type shoes, and may be carried out by using an injector and a mold. Preferably, it may be carried out by injecting into a mold at 150 to 200° C. from an injector at 60 to 120° C., and more preferably by injecting into a mold at 160 to 190° C. from an injector at 80 to 100° C. Thereafter, it may be carried out by injecting for 100 to 500 seconds, preferably by injecting for 200 to 400 seconds.

On the other hand, as described above, shoes may be manufactured by using a foamed rubber composition, and, preferably, shoes having a foaming ratio of 120 to 180% may be manufactured. In this case, the injection-type shoes show excellent durability, waterproofness and lightness.

Accordingly, the block type outsole and the shoe manufacturing method comprising same of the present invention can firmly couple the block type outsole 11 to the base portion 12 without a separate bonding or assembling process in the process step and thus firmly couple the outsole without an adhesive only by using a simple process, thereby providing the shoe with excellent durability, and the present invention undergoes no hydrolyzation of an adhesive even in wet places and causes no concern of being detached from the shoe due to reduced adhesion, thereby providing the shoe with excellent waterproofness. In addition, the present invention can greatly reduce process cost and remarkably improve process efficiency.

Hereinafter, the present invention will be described in more detail through specific examples.

### Example 1

A resin composition was added to a kneader and mixed at 60 to 80° C. for 5 minutes. Then, an additive was added and further mixed for 7 to 8 minutes. Thereafter, a crosslinking accelerator was added and further mixed for 1 to 2 minutes to prepare a mixture for preparing an outsole base portion. The mixture was rolled by rolling at 60 to 80° C. for 5 minutes. The rolled mixture was extruded in an extruder at 80 to 100° C. and then cut to prepare pellets. The pellets were injected into a mold at 170 to 175° C. from an 80 to 100° C. injector and then injection molded for 300 seconds to prepare a 150% foam base portion. A last was inserted immediately after manufacturing the base portion. Thereafter, a block type outsole was inserted thereinto. The process was carried out by passing the mixture through a 20 m conveyor belt set at 70° C./60° C./50° C. for 20 to 23 minutes. Thereafter, through a stabilization step, shoes comprising a block type outsole were manufactured.

1. A block type outsole, comprising:
a fixing portion fitted and fixed to the base portion in which at least one insertion portion is formed;
a protrusion portion formed to face the fixing portion; and
a connecting portion connecting the fixing portion and the protruding portion,
wherein the block type outsole is fitted into the insertion portion and coupled to the base portion.

2. The block type outsole of claim 1, characterized in that the fitting is formed without an adhesive.

3. The block type outsole of claim 1, characterized in that an intaglio pattern is formed on the protruding outer surface of the protrusion portion.

4. The block type outsole of claim 1, characterized in that at least one anti-slip pin is formed on the protruding outer surface of the protrusion portion, and the anti-slip pin is formed to protrude toward the walking path and be exposed to the outside.

5. The block type outsole of claim 1, characterized in that it satisfies the following Formula 1:
A_{F}>A_{c} [Formula 1]
wherein A_{F} is a cross-sectional area of the fixing portion, and A_{c} is a cross-sectional area of the connecting portion.

6. A shoe comprising the block type outsole of claim 1.

7. The shoe of claim 6, characterized in that the base portion may be any one selected from the group consisting of a bottom portion of the shoe itself, a midsole, and a base outsole to which a block type outsole may be coupled.

8. A method of manufacturing a shoe comprising a block type outsole, characterized in that it comprises the step of molding the pellet-type rubber composition for manufacturing a shoe,
wherein the step of molding the pellet-type rubber composition comprises the steps that;
the melt of the pellet-type rubber composition starts to shrink into the form of a shoe comprising a base portion in which at least one insertion portion is formed;
a block type outsole is inserted into the insertion portion during shrinkage of the melt; and
the shrinkage of the melt is completed such that the block type outsole is fixed in close contact with the insertion portion.

9. The method of manufacturing a shoe of claim 8, characterized in that the step of inserting the block type outsole is carried out by fitting the block type outsole into the base portion without an adhesive.

10. The method of manufacturing a shoe of claim 8, characterized in that the step that the block type outsole is inserted into the insertion portion is carried out within 300 seconds after the melt is molded and begins to shrink.

11. The method of manufacturing a shoe of claim 8, characterized in that the step of molding the pellet-type rubber composition is carried out by injecting the melt from an injector at 80 to 100° C. into a mold at 160 to 190° C. for 200 to 400 seconds.

12. The method of manufacturing a shoe of claim 8, characterized in that the step of molding the pellet-type rubber composition obtains a shoe foamed with 120 to 180%.
